(19) United States
(12) Patent Application Publication
(10) Pub. No.: US 2016/0273585 A1
(43) Pub. Date: Sep. 22, 2016

(54) ROLLER BEARING, IN PARTICULAR FOR A MIRROR OF A MOTOR VEHICLE

(71) Applicant: Thomas Perrotin, Saint Roch (FR)

(72) Inventor: Thomas Perrotin, Saint Roch (FR)

(73) Assignee: Aktiebolaget SKF, Goteborg (SE)

(21) Appl. No.: 15/071,382

(22) Filed: Mar. 16, 2016

(30) Foreign Application Priority Data
Mar. 18, 2015 (FR) 1552229

(51) Int. Cl. F16C 33/38

(52) U.S. Cl. CPC F16C 33/3806; F16C 19/06

(57) ABSTRACT

A roller bearing having a first ring, a second ring, at least one row of rolling elements arranged between the rings, and a cage for keeping the rolling elements circumferential in relation to one another. The cage includes first axial retaining means for the first ring and second axial retaining means for the second ring.

### CROSS REFERENCE TO RELATED APPLICATION

This is a Non-Provisional Patent Application, filed under the Paris Convention, claiming the benefit of French (FR) Patent Application Number 1552229, filed on 18 Mar. 2015, which is incorporated herein by reference in its entirety.

### TECHNICAL FIELD OF THE INVENTION

The present invention relates to the domain of roller bearings, in particular roller bearings used in wing mirrors on motor vehicles.

### BACKGROUND OF THE INVENTION

Conventionally, such a bearing comprises first and second rings, a row of rolling elements arranged between the rings and a cage for maintaining the circumferential spacing of the rolling elements. Before assembly of the mirror, there is a risk of accidental disassembly of the elements making up the roller bearing, for example during storage, carriage or assembly.

In another application, a roller bearing is known from patent applications FR-A1-2 806 135 and FR-A1-2 915 778 that is fitted with a cage for maintaining the circumferential spacing of the rolling elements that includes retaining hooks on the outer ring and retaining hooks on a sleeve or tolerance ring assembled in the bore of the inner ring.

Such a design is not however suitable for use in a wing mirror of a motor vehicle.

### SUMMARY OF THE INVENTION

The present invention is intended to provide a roller bearing, in particular a wing mirror of a motor vehicle, having a limited risk of detachment of the elements making up the bearing.

In one embodiment, the roller bearing comprises a first ring, a second ring, at least one row of rolling elements arranged between the rings, and a cage for keeping the rolling elements circumferential in relation to one another. The cage comprises first axial retaining means for the first ring and second axial retaining means for the second ring.

The roller bearing forms a unitary assembly that can be handled, transported and assembled with limited risk of detachment of the rings from the cage.

The cage may include a holding portion for the rolling elements provided with a plurality of cells for the rolling elements, and a flange axially extending the holding portion and from which the first and second axial retaining means project.

Preferably, the first and second rings cooperate respectively with the first and second axial retaining means of the cage. The rings are arranged axially at least partially between the related axial retaining means and the holding portion of the cage. In one embodiment, the first and second rings each have at least one projection cooperating respectively with the first and second axial retaining means of the cage, the projections being arranged axially between the related axial retaining means and the holding portion of the cage.

The cage may be formed as a single part, in particular by moulding a synthetic material. Once the cage has been formed by moulding, the first axial retaining means are preferably offset around the circumference in relation to the second axial retaining means. Advantageously, a slot is formed through the holding portion of the cage axially opposite each of the first and second axial retaining means, each of the slots having a circumference equal to or greater than the circumference of the related hook. The design of the production mould for the cage is simple inasmuch as the mould does not require any movable slides to mould and demould the hooks.

In one embodiment, each of the first and second axial retaining means includes a radial stop surface axially opposite the related ring.

In one embodiment, the first and second axial retaining means each has a plurality of hooks spaced apart from one another around the circumference.

The first and second axial retaining means may be arranged axially on either side of the rolling elements.

In one embodiment, the flange of the cage radially surrounds the first and second rings. Alternatively, the flange of the cage projects into the bores of the first and second rings.

The invention also relates to an assembly, in particular a vehicle mirror, including a roller bearing as defined above.

### BRIEF DESCRIPTION OF THE DRAWINGS

The present invention is further described in the detailed description of an embodiment provided by way of nonlimiting example and illustrated in the attached drawings, in which:

FIG. 1 is an axial half cross-sectional view of a roller bearing according to an example embodiment of the invention,

FIGS. 2 and 3 are perspective views of a cage of the bearing in FIG. 1,

FIG. 4 is a half front view of the cage in FIGS. 2 and 3,

FIGS. 5 to 7 are respectively cross sections along the axes V-V, VI-VI and VII-VII in FIG. 4, and

FIG. 8 is a partial cross section of a production mould for the cage in FIG. 2.

### DETAILED DESCRIPTION OF THE INVENTION

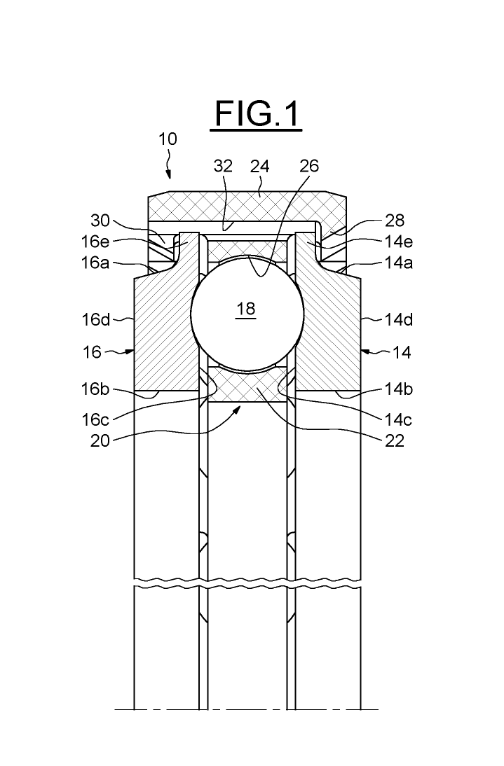

In FIG. 1, a roller bearing 10 with axis 12 includes a first ring 14, a second ring 16, a plurality of rolling elements 18, in this case balls arranged axially between the rings, and a cage 20 for maintaining the circumferential spacing of the rolling elements.

The rings 14, 16 are concentric. In the example embodiment shown, the rings are solid. “Solid ring” means a ring that is formed by machining tubes, bars or forged and/or rolled blanks with stock removal (turning, grinding).

The first ring 14 has a cylindrical outer surface 14a, a cylindrical bore 14b, two opposing radial front surfaces 14c, 14d axially delimiting the bore and the outer surface, and a race formed on the front surface 14c and having in cross section an internal concave profile adapted to the rolling elements 18, the race being oriented axially towards the inner ring 16. The first ring 14 also includes an annular projection 14e extending radially outwards from the outer surface 14a.

The second ring 16 is symmetrical with the first ring 14 about a median radial plane of the bearing 10. The second ring 16 has a cylindrical outer surface 16a, a cylindrical bore 16b, two opposing radial front surfaces 16c, 16d axially delimiting the bore and the outer surface, and a race formed on the front surface 16c and having in cross section an internal concave profile adapted to the rolling elements 18, the race being oriented axially towards the inner ring 14. The second ring 16 also includes an annular projection 16e extending radially outwards from the outer surface 16a.

The annular cage 20, with axis 12, is made as a single part. In the example embodiment shown, the cage 20 is formed by moulding a synthetic material such as polyamide, in particular PA 66 reinforced with glass fibres or otherwise.

The cage 20 has an annular radial holding portion 22 and an annular peripheral flange 24 axially extending a large-diameter edge of the holding portion. The holding portion 22 is arranged axially between the first and second rings 14, 16. The holding portion 22 is arranged axially inside the axial space delimited by the first and second rings 14, 16. More specifically, the axial space is delimited by the front surfaces 14c, 16c of the rings. The holding portion 22 includes a plurality of cells 26 that are regularly distributed around the circumference and designed to receive the rolling elements 18. The flange 24 radially surrounds the first and second rings 14, 16. The flange 24 is radially removed from the rings. The flange 24 extends axially between the front surfaces 14c, 16c while remaining axially set back from the surfaces.

The cage 20 also includes a plurality of first and second hooks 28, 30 respectively provided to ensure the axial retention of the first and second rings 14, 16. The hooks 28, 30 cooperate directly with the rings 14, 16 to ensure this rigid attachment in the axial direction. The hooks 28, 30 extend radially inwards from the flange 24 towards the rings 14, 16 with no radial contact between same.

In the example embodiment shown, the hooks 28 are arranged at one axial extremity of the flange 24 and the hooks 30 are provided at the opposite axial extremity of the flange. The hooks 28 and the hooks 30 are arranged axially on either side of the rolling elements 18. The hooks 28 are arranged axially on the side opposite the holding portion 22 in relation to the projection 14e of the first ring. In other words, the projection 14e is arranged axially between the holding portion 22 and the hooks 28 of the cage. The internal diameter of the hooks 28 is less than the external diameter of the projection 14e. The hooks 28 hold the first ring 14 and the cage 20 together by diametral interference in the event of relative axial movement between the ring 14 and the cage 20. The hooks 28 of the cage form axial retaining means cooperating with complementary axial retaining means of the ring 14 formed by the projection 14e. The hooks 28 cooperate with the projection 14e by clicking. The hooks 28 are spaced out from one another around the circumference, preferably regularly. In the example embodiment shown, there are six hooks 28. In a variant, a different number of hooks 28 may be provided, for example one, two, three, four, five, seven or more.

Each hook 28 of the cage has a radial stop surface (not referenced) oriented inwards and axially opposite the projection 14e of the ring. If the ring 14 moves axially in relation to the cage 20, the ring is held axially by axial contact between the hooks 28 and the projection 14e, and more specifically by axial contact between the stop surface of each of the hooks and the surface facing the projection 14e.

Each hook 28 also has an oblique surface (not referenced) that is oriented outwards and that is able to facilitate engagement of the projection 14e inside the cage 20.

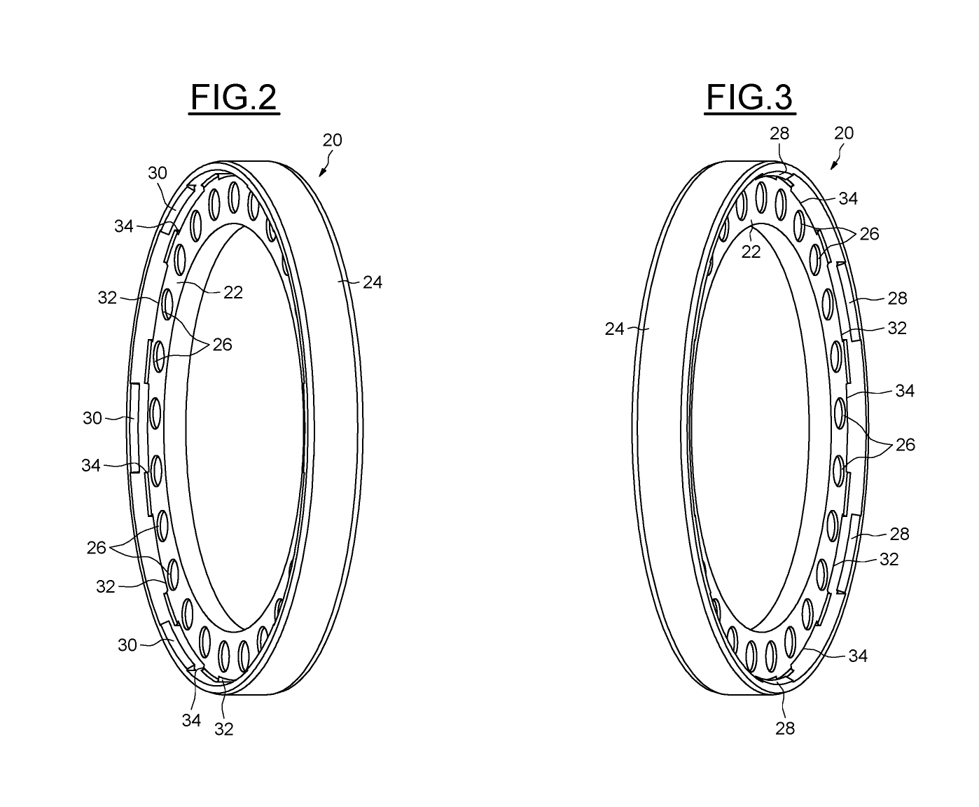

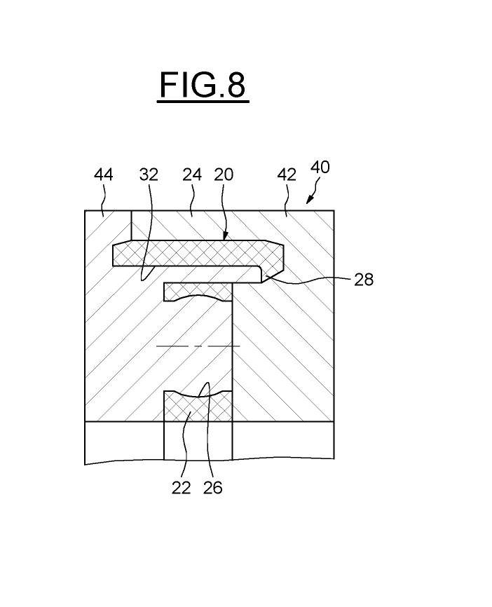

As shown more clearly in FIGS. 2, 3 and 5, the cage 20 has a plurality of first slots 32 extending axially through the holding portion 22. The slots 32 are through-holes. The slots 32 are spaced out from one another around the circumference such that they are aligned axially with the hooks 28. The circumference of the slots 32 is equal to the circumference of the hooks 28. The slots 32 are formed in the cage 20 to enable the moulding and demoulding of the hooks 28 using a production mould 40 (FIG. 8) comprising two parts 42, 44 and no moveable slides.

With reference to FIG. 1, the relative arrangement of the hooks 30 of the cage and of the projection 16e of the second ring is identical to the relative arrangement described for the hooks 28 and the projection 14e of the first ring. The internal diameter of the hooks 30 is less than the external diameter of the projection 16e. The hooks 30 hold the second ring 16 and the cage 20 together by diametral interference. Similarly to the hooks 28, each hook 30 of the cage has a radial stop surface oriented inwards and an oblique surface that is oriented outwards and that is designed to facilitate the engagement of the projection 16e of the ring inside the cage 20. The hooks 30 are spaced out from one another around the circumference, preferably regularly. The hooks 30 are offset around the circumference in relation to the hooks 28 such that there are no areas of circumferential overlap between the hooks 28, 30. Each hook 28 is located circumferentially between two successive hooks 30.

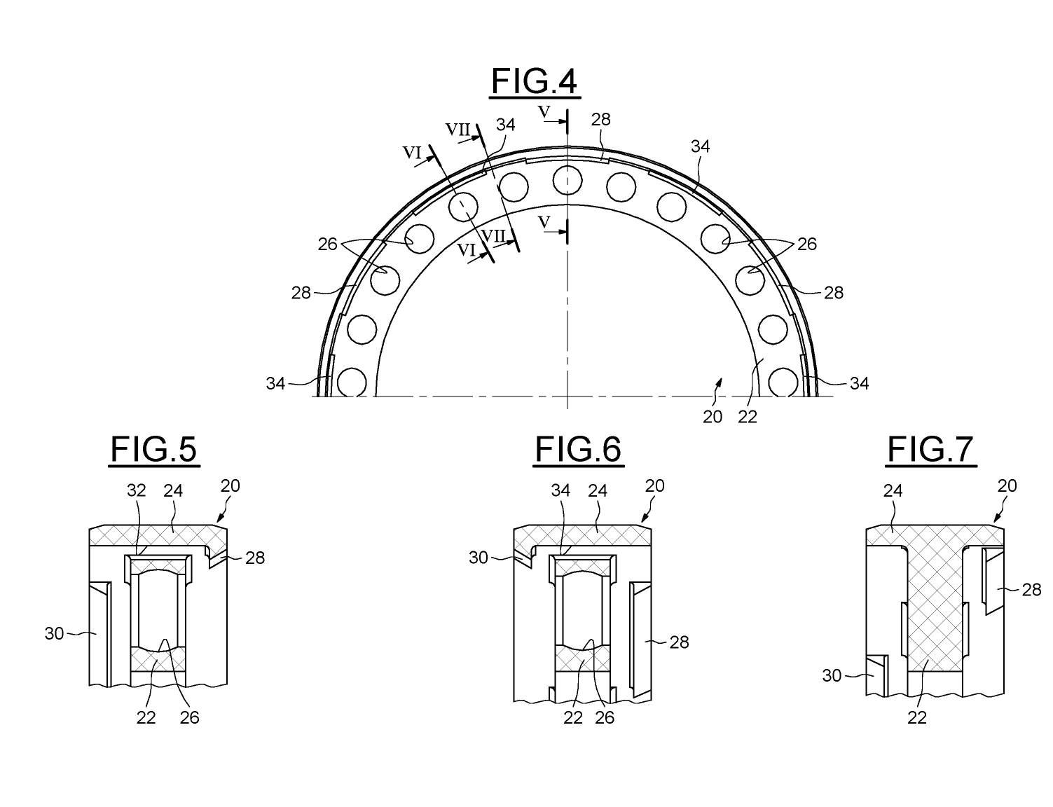

As shown more clearly in FIGS. 2 to 4 and 6, the cage 20 has a plurality of second slots 34 extending axially through the holding portion 22. The slots 34 are through-holes. The slots 34 are spaced out from one another around the circumference such that they are aligned axially with the hooks 30. A slot 34 is arranged circumferentially between two successive slots 32. The circumference of the slots 34 is equal to the circumference of the hooks 30. On one side of the cage 20, there are alternating hooks 28 and slots 34 around the circumference, as shown in FIG. 4, and the slots 32 and hooks 30 on the other side are also arranged alternately. Similarly to the slots 32, the slots 34 are provided on the cage 20 to enable moulding and demoulding of the hooks 30 without having to provide movable slides for the related production mould 40 (FIG. 8).

In the example embodiment shown, each projection 14e, 16e of the rings is in the form of an annular rib, i.e. continuous around the circumference. Alternatively, the rings 14, 16 may each have a plurality of projections spaced apart from one another around the circumference and cooperating with the related hooks 28, 30.

In the example embodiment shown, the outer flange 24 of the cage extends a large-diameter edge of the annular holding portion 22 and radially surrounds the rings 14, 16 at least in part. The hooks 28, 30 form outer hooks extending radially inwards. Alternatively or additionally, the cage 20 may include an internal flange extending a small-diameter edge of the holding portion 22 and extending into the bores of the rings 14, 16. In this variant, the cage 20 includes, instead of or as well as the outer hooks, inner hooks extending radially outwards from the inner flange.

In the example embodiment shown, an identical number of hooks 28 and 30 are provided to hold the rings 14, 16 axially. Alternatively, the number of hooks 30 may be different to the number of hooks 28.

In the example embodiment shown, the cage 20 is made by moulding a synthetic material. In order to simplify the design of the related production mould, the hooks 28 are not positioned axially opposite the hooks 30, but are offset around the circumference. In a variant embodiment, the cage 20 can be made of metal, for example by cutting and stamping a thin plate section. In this case, the holding portion of the cage need not have such slots.

The invention provides a roller bearing forming a unitary assembly that can be stored, transported and assembled with a low risk of disassembly. The assembly of each of the rings on the sub-assembly comprising the cage and the balls may be effected simply by pushing axially.

In the application envisaged, the bearing forms an axial stop for a row of balls designed to be used in a wing mirror of a motor vehicle. The bearing may nonetheless be used in other applications and may include rolling elements other than balls, for example cylindrical or conical rollers, and/or a plurality of rows of rolling elements. In the example embodiment shown, the cage of the bearing is designed to ensure a circumferential spacing of the rolling elements in relation to one another. In a variant, the cage of the bearing may be designed to merely hold the rolling elements without spacing out the elements in relation to one another, i.e. with contact between the rolling elements.

1. A roller bearing comprising:
a first ring,
a second ring,
at least one row of rolling elements arranged between the rings, and
a cage for holding the rolling elements circumferential in relation to one another, wherein the cage includes first axial retaining means for the first ring and second axial retaining means for the second ring.

2. The roller bearing according to claim 1, wherein the cage includes a holding portion for the rolling elements provided with a plurality of cells for the rolling elements and a flange axially extending the holding portion and from which the first and second axial retaining means project.

3. The roller bearing according to claim 2, wherein the first and second rings cooperate respectively with the first and second axial retaining means of the cage, the rings being arranged axially at least partially between the related axial retaining means and the holding portion of the cage.

4. The roller bearing according to claim 1, wherein the first axial retaining means are offset circumferentially in relation to the second axial retaining means.

5. The roller bearing according to claim 2, wherein the first axial retaining means are offset circumferentially in relation to the second axial retaining means and wherein a slot is formed through the holding portion of the cage axially opposite each of the first and second axial retaining means, each of the slots having a circumference at least equal to the circumference of the related hook.

6. The roller bearing according to claim 1, wherein each of the first and second axial retaining means includes a radial stop surface axially opposite the related ring.

7. The roller bearing according to claim 1, wherein the first and second axial retaining means each have a plurality of hooks spaced apart from one another around the circumference.

8. The roller bearing according to claim 1, wherein the first and second axial retaining means are arranged axially on either side of the rolling elements.

9. The roller bearing according to claim 1, wherein the flange of the cage radially surrounds the first and second rings.

10. An assembly for a vehicle, the assembly comprising:
a mirror including a roller bearing having;
a first ring,
a second ring,
at least one row of rolling elements arranged between the rings, and
a cage for holding the rolling elements circumferential in relation to one another, wherein the cage includes first axial retaining means for the first ring and second axial retaining means for the second ring.
